(19) United States
(12) Patent Application Publication
(10) Pub. No.: US 2006/0085826 A1
(43) Pub. Date: Apr. 20, 2006

(54) Aggregated program guide for download and view video on demand service

(76) Inventors: James M. Funk, Menlo Park, CA (US); Steve Shannon, Hillsborough, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/968,232

(22) Filed: Oct. 18, 2004

(51) Int. Cl. H04N 7/173; G06F 3/00; G06F 13/00; H04N 5/445

(52) U.S. Cl. 725/87; 725/112; 725/39; 725/109

(57) ABSTRACT

An aggregated program guide contains entries of programs available for downloading and viewing including details such as network location of the programs and download status. The guide further contains information about viewing rights and is made available for download from a network server different from content servers on which the programs are available for download.

### BACKGROUND OF THE INVENTION

1. Field of Invention

The invention relates generally to the fields of video on demand (VOD) and Electronic Program Guides (EPG). More specifically, the invention relates to aggregating metadata from disparate content providers and making an EPG available to VOD clients from a server other than the one where content is available for downloading and viewing.

2. Description of Related Technology

A program guide offers its viewers information regarding what is available for viewing, at what time and which channel is it on. Creation and transmission of EPGs in multi-channel networks such as broadcast and pay television networks is well known in the conventional art. In these networks, EPG metadata is transmitted in the form of tables (e.g., System Information (SI) Tables of the Digital Video Broadcast (DVB) standards) to help a client device assemble a local copy of the program guide.

Recently, the concept of a broadcast program guide has been extended to accommodate VOD services. For example in coaxial cable networks, when a user launches the program guide application resident on his/her set-top box, information about what is available on VOD servers is presented. When user selects a program to watch, content is transferred to the user in a substantially real time manner, from content servers that are typically operated and managed by the VOD service provider. Although some content is cached locally during the display process (e.g., in order to accommodate the I, B and P pictures of MPEG data transmissions), it is not accessible to the user to view off-line or at a different time.

With the recent advances in computer and telecommunication technologies, a different content distribution model, namely one where content is downloaded via the Internet to a local storage device and viewed at a later time (i.e., the “download-and-view” model), is emerging as a popular method for content distribution. For this new distribution model, some EPG requirements have stayed the same as for the conventional VOD services. These requirements include, for example, being able to convey details about the content such as the cast, story line, content advisory rating, and so on. However, a new set of requirements has also arisen. This includes, without limitation, the need to know the network location of the content, whether the content has already been downloaded to local storage for viewing; and, if such downloading has not yet been completed, when downloading is expected to be finished such that the content will become available for viewing, and so on.

The large number of content providers who could contribute content and program information to such a download-and-view service, the dynamic nature of the content, and the need to add/remove entries frequently from the database of content guide information cannot be addressed by conventional methods for assembling and distributing EPGs.

Moreover, for a download-and-view VOD service, the guide should also provide sufficient information for a client device to obtain not only the requested content but also information regarding the location of servers where a license for viewing the content can be obtained.

Based on the foregoing, it will be evident that while the prior art has in general recognized the utility of EPGs, it lacks a method to adequately address many of the requirements and intricacies associated with deploying and using such guides in the field of download and view VOD.

### SUMMARY OF THE INVENTION

The present invention addresses the foregoing needs by providing, in various embodiments, a method and apparatus for creation and distribution of an EPG that includes metadata describing VOD content available for download via the Internet to a VOD client. This content is available from multiple disparate content sources, one or more of which are unique from an Internet host of a VOD system at which the EPG is made available for retrieval by the VOD client. The metadata is aggregated from content providers associated with the VOD content and formatted according to a common schema for presentation within the EPG. The metadata may include pricing information, titles for the VOD content, cast and crew information for the VOD content, audience rating information for the VOD content, and recommendation information regarding the VOD content.

In a second aspect of the invention, a method of aggregating metadata describing VOD content available for download via the Internet from multiple disparate content providers is provided. The method further includes formatting the metadata according to a common schema used by a VOD EPG, and distributing the VOD EPG from a host to one or more VOD clients, the host being distinct from one or more content sources from which the VOD content is available for download by the VOD client. In one exemplary embodiment, the host is an Internet host and the EPG is distributed via the Internet. In another exemplary embodiment, the EPG is distributed in response to a request therefor from a VOD client. A further method to display the EPG through a display device communicatively coupled to the VOD client is provided.

In a third aspect of the invention, a method of managing digital rights in multimedia viewing, including distributing an EPG containing metadata describing VOD content available for download via the Internet from multiple disparate content providers, and authorizing, in connection with a download of the VOD content from an Internet host other than that at which the EPG is available is disclosed. In one exemplary embodiment of the invention, the method further includes distributing the VOD EPG in response to a request therefor from the VOD client.

### BRIEF DESCRIPTION OF THE DRAWINGS

The above and other features and advantages of the present invention are hereinafter described in the following detailed description of illustrative embodiments to be read in conjunction with the accompanying drawings and figures, wherein like reference numerals are used to identify the same or similar system parts and/or method steps, and in which:

FIG. 1 illustrates a communication network showing an exemplary embodiment of the present invention as a system that includes VOD client device with local storage capability, multiple content servers and an EPG server, all communicatively coupled to each other through the network.

FIG. 2 overlays on the communication network of FIG. 1 details of signals exchanged among different network elements in an exemplary embodiment of the present invention. These signals include messages exchanged for creation of a program guide, content discovery and content download.

FIG. 3 illustrates an exemplary embodiment showing steps taken according to the present invention to aggregate program guide, provide it to a client device, monitor accuracy of the guide entries and obtain a license to view the content after finishing its download.

FIG. 4 illustrates in details the step of obtaining a license to view content as per an exemplary embodiment of the present invention. The illustration shows messages exchanged among a VOD client device, VOD servers and license manager servers to download and view content.

### DETAILED DESCRIPTION

Reference is now made to the drawings wherein like numerals refer to like parts throughout. Described herein is an aggregated program guide for use in connection with downloading multimedia content to a personal video client device. The present invention overcomes the limitations of above-described systems, in part by providing an EPG that includes metadata describing VOD content available for download via the Internet to a VOD client. This content is available from multiple disparate content sources, one or more of which are unique from an Internet host of a VOD system at which the EPG is made available for retrieval by the VOD client. The metadata is aggregated from content providers associated with the VOD content and formatted according to a common schema for presentation within the EPG. The metadata may include pricing information, titles for the VOD content, cast and crew information for the VOD content, audience rating information for the VOD content, and recommendation information regarding the VOD content.

As used herein, the terms “content” and “program” are used substantially similarly and refer to audio, video, graphics files (in uncompressed or compressed format), icons, software, text files and scripts, data, binary files and other computer-usable data used to operate a client device and produce desired audio-visual effects on a client device for the viewer.

As used herein, the term “VOD” is meant to include on-demand delivery of content.

As used herein, the term “client device” is meant to include any manner of computer-based equipment capable of being communicatively coupled to one or more content sources (e.g., via the Internet and an applicable communication device such as a modem) to download multimedia content to a local computer-readable medium for later playback through a display device. The display device may, but need not, be integral to the client device. Often, the client device will be a set-top box.

As used herein, the term “content provider” refers to a person or business entity that makes multimedia content available to the users of a VOD service. No particular assumptions about a business relationship between the content provider and the VOD service provider are critical to the present invention. Content providers may, in some instances, be large commercial enterprises such as movie studios, television broadcasters and the like. In other cases, the content providers may be individuals, small businesses, independent movie producers and so on. Thus, the term content provider is used generally to describe any person or entity that wishes to make content (and particularly audio-video content) available to others. Often, though not necessarily, the content will be made available for a fee.

As used herein, the term “VOD service provider” refers to a commercial entity that provides an end user a VOD service including the ability to browse through available program titles, download content of interest and view it. As was the case for the content provider, the VOD service provider can be any form of entity or an individual. In general, the VOD service provider need not be a network facilitator. For example, where the Internet is used as the distribution channel for the content, the VOD service provider need not be an Internet service provider, network operator or associated with any form of network infrastructure provision. Instead, the VOD service provider may operate one or more Internet hosts configured to provide the program guide described below and to facilitate the distribution of metadata regarding content available for download to end users thereof. Often, though not necessarily, the VOD service provider will operate Internet hosts from which the content is available for download, however, this is not critical to the present invention. The VOD service may make use of special or general purpose computer systems configured to download and display the Internet content using any of a variety of communication and presentation applications. The precise nature of such application programs and, indeed, the nature of the computer systems on which the content is played back is not critical to the present inventions except insofar as the discussion below indicates.

In view of the above, it should be appreciated that some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented with an apparatus to perform the operations described herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the present invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, etc.), as taking an action or causing a result. Such expressions are merely a shorthand way of saying that execution of the software by a computer causes the processor of the computer to perform an action or produce a result.

### DESCRIPTION OF EXEMPLARY EMBODIMENTS

Download-and-View VOD Service

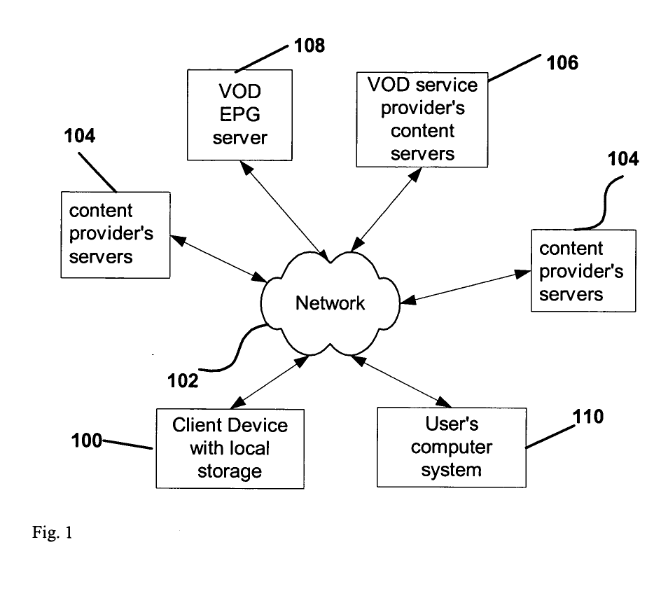

FIG. 1 shows an example deployment of a download-and-view VOD service deployment showing a client device with local storage capability (100). This client device is communicatively coupled with multiple servers via a network 102. These servers include the content provider's servers 104 (including, but not limited to, file transfer servers, licensing servers, web servers and so on), the VOD service provider's content servers 106 and the VOD service provider's one or more servers (108) on which an aggregated program guide is made available for download. Also shown in FIG. 1 is a computer system (110) such as a user's personal computer that is communicatively connected to the servers. Using this connection to the various servers, a VOD subscriber can perform one or more of same tasks that he/she can perform using the client device (e.g., but not limited to, content discovery, account management etc.). A method of managing the client device through such a computer system is disclosed in co-pending U.S. patent application Ser. No. ______ (Attorney Docket No. 7177P002) entitled “Method and apparatus for management of video on demand client device” filed ______, 2004, assigned to the assignee of the present invention and incorporated herein by reference.

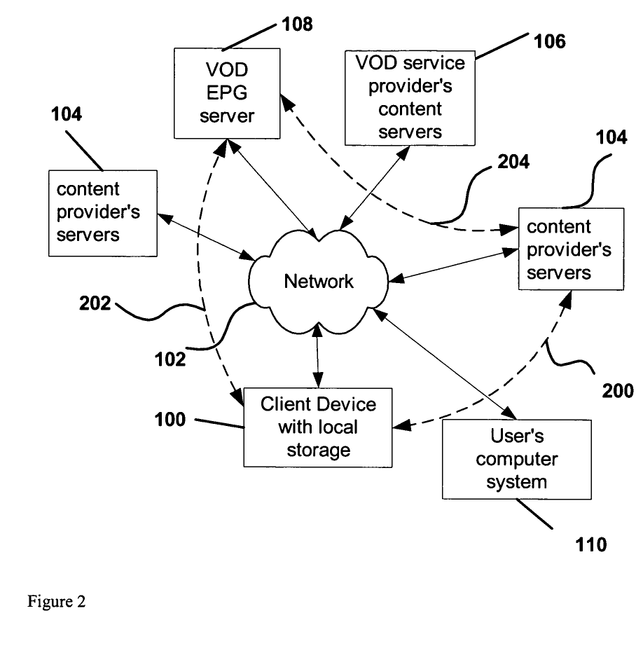

FIG. 2 overlays on the servers and client device of FIG. 1 details of high level communication performed in the download-and-view VOD service. Note that the details of communication are not meant to be exhaustive, but are included to enable readers to more fully appreciate various aspects of the present invention. Communication link 200 represents communication between a content provider's servers and the VOD client device for tasks such as, but not limited to, download of content, digital rights authentication and content discovery. Similarly, communication link 202 represents communication between the VOD client device and the VOD service provider's servers that includes tasks such as, but not limited to, download of EPG data, content download, subscription and account management and so on. As noted before, some or all of this communication can also be performed between the VOD service provider's servers and a VOD service user's computer system (such as a PC) 110 different from the client device 100. Another communication link 204 shown between content provider's servers and the VOD service provider's servers represents communications such as, but not limited to, business transactions between the two entities, uploading of content metadata, transfer of content for hosting or reviewing purposes and so on.

In the rest of this disclosure, these communications, along with other details of the present invention, are described in more details.

Content Discovery

While the combination of Internet connectivity and local storage available at client device 100 provides the technical feasibility to distribute Internet content, the task of searching for and downloading such content from the myriad of content providers that exist today remains a cumbersome process and, indeed, one that begins to become unmanageable as the number of websites of interest to a user grows. Even when the download process is partially automated (e.g., using techniques such as bookmarks and auto-updates), content searches still must be performed manually. Because of these and other complications, even if users find content of interest, it remains difficult to make purchasing decisions without further information such as a program guide, reviews, content advisory ratings, charges and credibility of the content provider.

With the availability of an aggregated guide as described herein, a user is able to browse through a single source using various methods, such as a parental ratings filter, keyword searches in the description, content available on special promotions, recommendations from other users, etc.

It should be noted that while the aggregated guide is envisioned to be the most common method by which users search and discover content, it is not the only method. Content could be discovered by users while being connected to the network via a connection other than their VOD client device. For example, a user may come upon content of interest while browsing the Internet.

Since a client device used for the download-and-view service has local storage capability, some programs displayed on the EPG could in fact be located entirely or in part on the local storage. According to an embodiment of the present invention, such programs are indicated in a visually different style than programs currently on a server connected to the network and available for download. Various embodiments of such visual differentiation are possible, including but not limited to, different color, font, size, transparency of graphics, arrangement of locally available titles as a separate screen or web page that the user navigates to, and so on. Similarly, in another embodiment of the present invention, programs that are partially downloaded can also be displayed in a visually distinct style including information such as time to completion, percent downloaded, and so on.

Aggregation of Program Guide Related Metadata

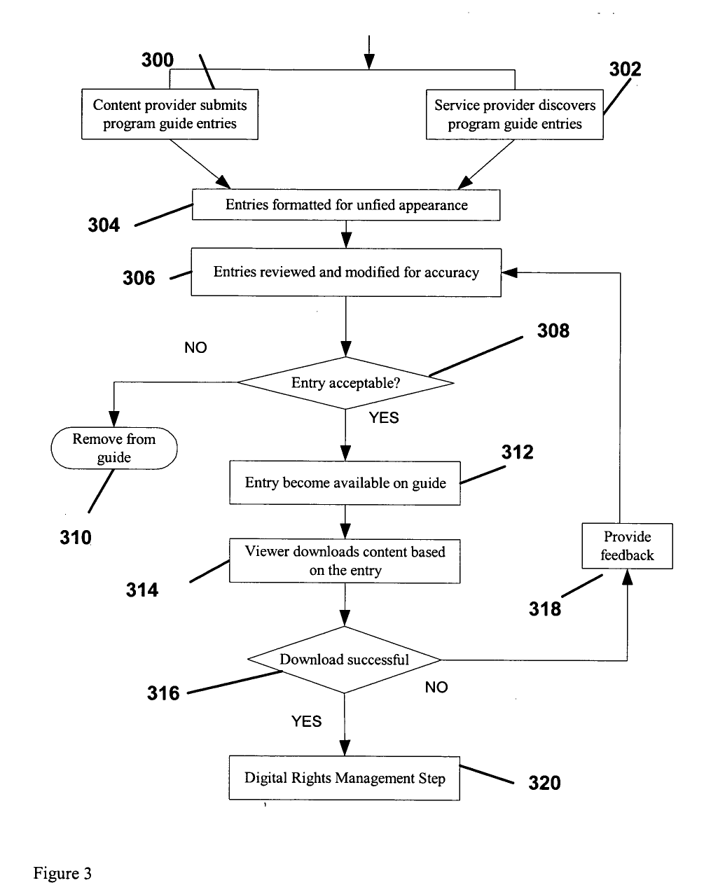

An aggregated program guide provides a convenient way for a user to perform content discovery. For example, consider that the aggregated guide is a comprehensive database of all possible user selections, and each user uses a “filter” based on his/her personal preferences to view some or all entries of this database. FIG. 3 shows various steps taken in performing such aggregation of metadata related to all programs available to a user for downloading and viewing, further described below in detail.

Push Pull Methods of Aggregation

As shown in step 300, program guide metadata could be submitted to the EPG server (e.g., using mechanisms such as the provider console disclosed in U.S. patent application Ser. No. ______ filed ______, 2004 assigned to the assignee of the present invention and incorporated herein by reference) or could be obtained by the server using a mechanism to search for such data (302). The former method is called a “push model” of EPG metadata aggregation and the latter method is called a “pull model.” Metadata could be “pulled” from content providers that have business relationship with the VOD service provider, or from network locations that maintain content which periodically changes (e.g., news programs).

Metadata Reformatting

Data thus obtained is optionally re-formatted in step 304. Program guide metadata is obtained using various data transfer methods such as e-mail, file transfer protocol (ftp) programs, or web interface (for example, the above-referenced provider console). Each content provider could have used different syntax and software tools to create their metadata. The re-formatting is done with two important goals in mind. First, to achieve visual and semantic uniformity. In one embodiment this involves performing one or more of the following steps:

Font, colors, graphics, icons etc. used according to rules of publishing

Spelling convention (e.g., U.S. English)

Creation of consistent content advisory ratings

Currency translation for viewing charges

The second goal is to make sure EPG metadata is converted to a format that enables easy repurposing and search of the metadata (for example, support for various ways of searching such data by embedding bookmarks). This step involves creation of a searchable database from the metadata obtained by the push and pull methods. This step could optionally fill in some fields of the metadata that have not been explicitly filled by the content providers (e.g., automatically providing a content provider's logo).

Metadata Review

Step 306 shows a review step based on content metadata thus aggregated. This optional step can be manual or automated or both. In one embodiment, control is provided for a human operator to review and accept, accept with modification or reject with comments the entries of the EPG. Such a manual review step could provide a level of confidence to the user in making a decision to purchase content.

If in the review process, an entry is deemed to be unacceptable for inclusion in the program guide (306), it is removed from the database of available programs (310) and an appropriate corrective action is taken (e.g., notification to the content provider). Otherwise, the entry is added to the program guide (312).

Broken URLs

A program thus made available in the program guide will be downloadable by a user for viewing (314). This program may be hosted on a server under the control of the VOD service provider, the content provider or a third-party server communicatively connected to the VOD client. The guide therefore contains sufficient information for the VOD client to locate and download the content selected by the viewer. Various mechanisms are possible to provide such information. In one embodiment, such information is provided as a Uniform Resource Locator (URL) of the network location of the content.

In an exemplary implementation, such download is performed under the control of a download manager residing on a client device (e.g., the “fetcher” mechanism disclosed in the co-pending U.S. patent application Ser. No. 10/928,451 (Attorney Docket. No. 7177P001) entitled “Method and apparatus for downloading content” filed Aug. 27, 2004, assigned to the assignee of the present invention and incorporated herein by reference). A key feature of the fetcher mechanism referenced above is that it maintains periodic communication between the client device on which it is running and the VOD service provider's servers. When the download manager is not able to download content from a URL entry in the guide metadata, the error is cached (316) as a message to be sent back to the VOD service provider. Broken URLs are notified at the next possible periodic communication between the download manager and the VOD service provider's servers. In another exemplary embodiment, the review process 306 includes a step to ensure validity of the URL provided for program by providing means of program review.

Digital Rights Management

When a program entry is added to the EPG database, as described above, information regarding viewing rights is included to help track and bill download and viewing for the content. In one exemplary embodiment, a content provider is given the following three choices to choose from: use their DRM and host content on a server of their choice, use their DRM but have the VOD service provider host the content or use the VOD service provider's DRM and content servers. Various other distribution and DRM modes are possible.

In one exemplary embodiment, when content is successfully downloaded (316), the client device goes on to obtain a license to view the content (320). When this transaction is completed such content can then be viewed without the need to have a connection to the network. For example, a VOD subscriber could download content, complete the DRM authentication step 320, then un-plug the device from the network, and yet still be able to view the content.

Viewing License and Authentication

One implementation of step 320 includes the client device communicating with a license manager hosted either by the VOD service provider or by the content provider (or a business partner thereof).

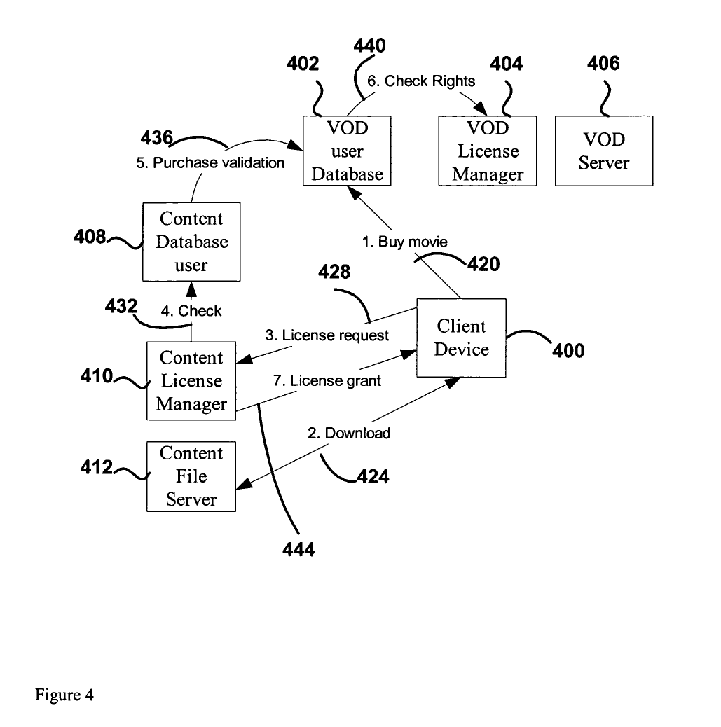

FIG. 4 shows an exemplary embodiment of a download-and-view VOD system that includes an aggregated program guide and processes for digital rights management.

The client device 400 receives the aggregated program guide from the server 402 labeled in FIG. 4 as “VOD user database.” Among other things, this functional unit is responsible for receiving guide requests from users, verifying that the users are authorized to receive the content and/or other materials requested and sending out the aggregated guide to the users. When a user wants to purchase a program for downloading and viewing, a message 420 titled “1. Buy request’ is sent the VOD service. Such a request may be initiated by a user in response to reading about the content in the aggregated program guide. The content itself may be downloaded from any host, including a host that is not managed by the VOD service provider (as shown by connector 424 titled “2. Download”) such as content file server 412, based on the URL indicated in the program guide. In another embodiment (for example in an embodiment where the content provider chooses to host content at the VOD service provider's servers), this download may be performed from a VOD content server 406 managed by the VOD service provider. Depending on the embodiment, content being downloaded may or may not be encrypted. Furthermore, the download could be performed using a secure connection (e.g. SSL) and authentication (e.g., password protection).

When the download is completed, the client device 400 sends a request (shown by connector 428 titled “3. Licenses request”) to the content provider's license manager to get a license to view the downloaded content. Upon receiving this request, the license manager queries its database (connector 432, labeled “4. check”) to verify that the requesting user is authorized to watch the requested content. In some embodiments, this query will further result in a query 436 titled “5. Purchase validation” from the content provider to the VOD service provider's user database. The VOD service provider's user database may in turn need to check via a query 440 titled “6. check rights” to make sure the requesting user has viewing privileges for the requested program. Once an appropriate confirmation is returned to the applicable license manager, the user receives his/her authorization to view the content (that is, an appropriate license key is provided to the VOD client, as shown by connector 444 titled “7. License grant”). In an exemplary embodiment, after receiving viewing authorization, the user may disconnect the VOD client from the network and yet still be able to view the content, until such time as the license key authorization expires (e.g., after expiration of time or number of viewings allowed).

In some embodiments, when the license to view content is issued based on an expiration date, the VOD server may issue a command to the client device upon expiration of the license to delete the corresponding content from the client device's local storage. Alternatively, or in addition, if the client device logs indicate that the user has not yet viewed this content, the client device may be configured to automatically renew the license (or obtain a new license) so that the viewer is not unnecessarily inconvenienced.

In the foregoing specification, the invention has been described with reference to specific exemplary embodiments thereof. It will, however, be evident to those of ordinary skill in the art that various modifications and changes may be made thereto without departing from the broader spirit and scope of the invention as set forth in the appended claims. The specification and drawings are, accordingly, to be regarded in an illustrative rather than a restrictive sense and it should be understood that the following claims including all equivalents are intended to define the scope of the invention.

What is claimed is:

1. A video-on-demand (VOD) electronic program guide (EPG), comprising metadata describing VOD content available for download via the Internet to a VOD client from multiple disparate content sources, one or more of which are unique from an Internet host of a VOD system at which the EPG is made available for retrieval by the VOD client, the metadata having been aggregated from content providers associated with the VOD content and formatted according to a common schema for presentation within the EPG.

2. The VOD EPG of claim 1, wherein the metadata includes pricing information for downloading the VOD content to the VOD client.

3. The VOD EPG of claim 2, wherein the metadata further includes some or all of: titles for the VOD content, cast and crew information for the VOD content, audience rating information for the VOD content, and recommendation information regarding the VOD content.

4. A method, comprising aggregating metadata describing video-on-demand (VOD) content available for download via the Internet from multiple disparate content providers, formatting the metadata according to a common schema used by a VOD electronic program guide (EPG), and distributing the VOD EPG from a host to one or more VOD clients, the host being distinct from one or more content sources from which the VOD content is available for download by the VOD client.

5. The method of claim 4, wherein the host comprises an Internet host and he VOD EPG is distributed via the Internet.

6. The method of claim 5, wherein the VOD EPG is distributed in response to a request therefor from the VOD client.

7. The method of claim 4, further comprising displaying, by the VOD client and through a display device communicatively coupled thereto, the VOD EPG to a viewer.

8. The method of claim 7, wherein only those entries of the VOD EPG that are associated with VOD content that meets ratings criteria maintained by the VOD client are displayed.

9. A method of managing digital rights in multimedia, comprising distributing an electronic program guide (EPG) containing metadata describing video-on-demand (VOD) content available for download via the Internet from multiple disparate content providers, and authorizing, in connection with a download of the VOD content from an Internet host other than that at which the EPG is available, a viewing of the VOD content via a VOD client through which the EPG is accessible.

10. The method of claim 9, wherein the VOD EPG is distributed in response to a request therefor from the VOD client.
